(19) United States
(12) Patent Application Publication
(10) Pub. No.: US 2010/0030613 A1
(43) Pub. Date: Feb. 4, 2010

(54) SYSTEM AND METHOD FOR GRAPHIC DESIGN AND MEDIA REQUEST AND FULFILLMENT

(75) Inventor: Leah Williamson, Washington, DC (US)

Correspondence Address: DICKSTEIN SHAPIRO LLP, 1825 EYE STREET NW, Washington, DC, 20006-5403, US

(73) Assignee: A Group Design

(21) Appl. No.: 12/511,866

(22) Filed: Jul. 29, 2009

Related U.S. Application Data
(60) Provisional application No. 61/085,279, filed on Jul. 31, 2008.

(51) Int. Cl. G06Q 10/00; G06F 15/16

(52) U.S. Cl. 705/9; 709/219

(57) ABSTRACT

A method and system for purchasing a package containing art which includes selecting a package that includes a custom graphic design element from a group of available packages, purchasing the package selected, submitting specifications for the custom graphic design element, queuing the custom art for creation, utilizing the specifications to create the custom art, and storing the custom art in a digital asset management repository.

### CROSS-REFERENCE TO RELATED APPLICATION

This application claims benefit of U.S. Provisional Application No. 61/085,279, filed Jul. 31, 2008.

### FIELD OF THE INVENTION

The present invention relates generally to the field of graphic arts and marketing services and more particularly, a system and process for automating the request and fulfillment of creative services requirements.

### BACKGROUND OF THE INVENTION

A number of Web sites exist on the Internet, accessible via the World Wide Web, that allow customers to design and request custom visual media online, such as clothing at Cafepress®, or stationary at VistaPrint. When the customer designs his or her own custom product, both these Web sites, and others like them, allow customers to select from pre-existing graphic art or to upload their own graphic art, which is incorporated into the items purchased. The custom visual media that results is generally a combination of any graphic art uploaded by the customer and templates created by the company that runs the Web site. Any graphic art in the visual media, including but not limited to logos, graphics, and illustrations, must be created before it is incorporated into the design. Either the customer created the graphic art before accessing the site, or the customer selects the graphic art from a pre-created set, available for use on the Web site.

A number of Web sites and web-based programs, such as gettyimages® and Widen® allow users to perform digital asset management, i.e., storage and retrieval of their graphic art or asserts, including but not limited to digital photographs and animations. These systems allow users to at least catalog, store, upload, and retrieve these assets. However, these systems do not create the assets, as the user must possess an asset before adding it to this repository and managing it within the repository.

Whether accessing a Web site to design custom media or managing digital assets, the user must already possess any graphic art he or she wishes to incorporate or use.

In order to obtain custom graphic art, an individual works with a graphic artist. The graphic artist creates the custom graphic art after a back and forth exchange between the individual and the artist. This exchange or relationship includes an initial meeting and follow up meetings. Provided that the collaboration is successful, the individual receives custom art and/or at least one product which incorporates the custom graphic art, including but not limited a logo, a printed item, a promotional product, a Web site, a display item, an exhibit, an audio service or a video service, and a published CD or DVD, and the artist is paid for his or her services. However, this process can be time-consuming and may not result in the creation of the graphic art if there is a breakdown in the relationship between the artist and the individual. One cause of this breakdown is the discovery by the individual that the artist is not properly suited for the job. Additionally, each time the customer requires a new graphic element, he or she must participate in another initial meeting before moving forward, which is a time-consuming process.

### BRIEF SUMMARY OF THE INVENTION

This invention relates to the field of graphic art and design and is, more specifically, a method and system of creating custom graphic art for a customer through the use of a single method or system to request and fulfill a customer's graphic art requirements. This method and system allows a prospective customer to order custom graphic art by defining the specifications for the art, routes the order to a qualified artist, who fulfills the order according to the specifications, routes the completed order to the customer, and facilitates the management of each customer's completed and pending orders in a digital asset management repository. Additionally, if the customer possesses graphic art that he or she wishes to incorporate into a product, the method and system route this request to an appropriate vendor for fulfillment of this media request.

A need exists for a single method or system comprising a graphic art order management system and a digital asset management repository. This system and method allows a customer to commission and manage his or her digital assets while eliminating some of the time-consuming activities regularly associated with commissioning graphic art, including but not limited to finding a qualified designer with the skills and style that match the customer's needs, holding initial face-to-face meetings with prospective designers to define the specifications of the project and gauge the stylistic preferences of the customer, holding follow-up meetings with the designer to comment on the work-in-progress, and finding a vendor to produce a product that incorporates the custom graphic design.

Additionally, the method and system stream-lines the customer's ordering process for any subsequent orders by storing a customer profile that is utilized by any designer to whom orders are assigned as part of the specifications for each order. The method and system also allow the customer to utilize a plurality of potential graphic artists to fulfill a plurality of different graphic art needs.

The present invention provides interested parties, including at least customers, graphics professional, including but no limited to artists and vendors, with a system and method for graphic art order creation and fulfillment. The proposed system and method is comprised of coordinating and streamlining the efforts of customers, graphic artists, and vendors who deal with graphic designers by integrating the functions of the three parties into a single method and system.

### BRIEF DESCRIPTION OF THE DRAWINGS

FIG. 1 is a diagram that illustrates the general workflow of an embodiment of the present invention;

FIG. 2 is a diagram of the system architecture of an embodiment of the present invention;

FIG. 3 is a diagram of that illustrates the general workflow of an embodiment of a system which can be used to practice the invention.

### DETAILED DESCRIPTION OF THE INVENTION

The present invention comprises a system and method for fulfilling a customer's request for graphic art and/or a product which incorporates graphic art, including but not limited to a logo, a printed item, a promotional product, a Web site, a display item, an exhibit, an audio service or a video service, and a published CD or DVD. The system comprises one or more computers that interact with a user in order to define the specifications for the art, routes the order to a qualified artist, who fulfills the order according to the specifications, routes the completed order to the customer, and facilitates the management of the customer's order in a digital asset management repository during the creation process between the customer and the artists.

The present invention may be described herein in terms of functional block components, code listings, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, Visual Basic, Python, CGI, PHP or the like, with the various algorithms being implemented with any combination of data structures, objects, processes, routines or other programming elements. The object code created for the computers can preferably be executed by any general purpose computer such as a personal computer having an appropriate operating system such as Windows™ or MAC™ and an appropriate browser such as Internet Explorer,™ Netscape™ or Safari.™

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

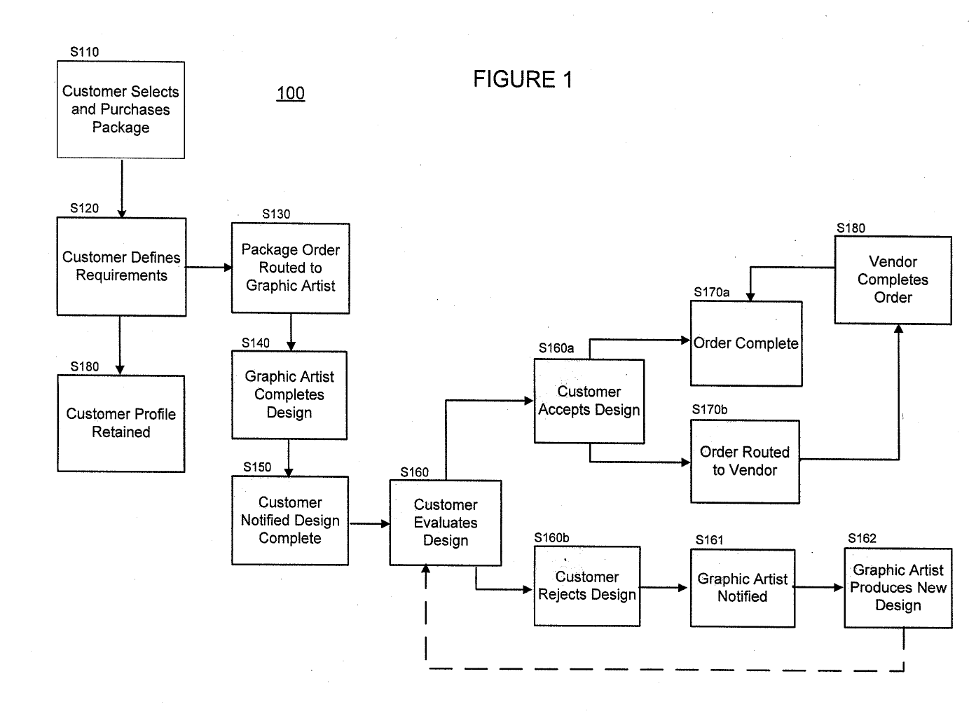

Referring the FIG. 1, the general workflow of the method 100 is shown. In this embodiment, a customer first purchases a package selected from a group of available packages (S110). The package represents graphic art or products incorporating graphic art, such as a custom graphic art product, including but not limited to a logo, a printed item, a promotional product, a Web site, a display item, an exhibit, an audio service or a video service, and/or a published CD or DVD. A package refers to both a group of graphic products or a single item, including but not limited to a hat, t-shirt, and a banner. At this point, the actual package that embodies the product that will be ultimately delivered to the client has not yet been created. It is created in collaboration with a graphic artist. However, this pre-purchase facilitates the further operation of the system and method.

Once the package is purchased, the customer defines the customized requirements or specifications for the package (S120). To define the specifications, the customer provides information including but not limited to specific data related to the type of package selected as well as general information about the customer itself, called a client profile, which will assist the assigned graphic artist in assessing both the needs and stylistic preferences of the customer.

When the specifications are complete, the package order is routed to a qualified graphic artist (S130) based upon an analysis of the order. In one aspect of the invention, the routing is handled by a job trafficker, an individual preferably with an artistic background, who can use this expertise to select an appropriate artist to create the package, based upon elements including but not limited to the package selected, the specifications submitted by the customer, and the skill sets of the available graphic artist. The job trafficker will then notify the selected graphic artist that he or she had been selected for the package and send the specifications to the selected graphic artist.

After receiving the specifications, the selected graphic artist completes the graphic design for the package (S140). Depending upon the nature of the package, this graphic design may signify the completed package, i.e., a fulfilled order. For example, if the package purchased is a logo, the graphic artist creates a logo in order to create the package, i.e., fulfill the order. However, if the package is a display item, such as a banner, although the graphic artist creates the design, the physical banner that includes the design may not be produced by the graphic artist, but instead routed to a vendor, such as a copy center, with the facilities and equipment to emboss graphic art onto a banner.

Once the graphic design for the initial package design is complete, the customer is notified by the graphic artist (S150).

Upon receiving notification that the design is complete, the customer evaluates the design (S160) to see whether it conforms to his or her needs and expectations. If the customer is satisfied with the design, he or she accepts the design (S160a). If the customer is not satisfied with the design, he or she rejects the design (S160b).

If the design is accepted by the customer (S160a), depending upon the type of package, either the transaction is complete, i.e. the order is fulfilled (S170a), or the design is routed to a vendor (S170b), who will create the final package and deliver it to the customer (S180), fulfilling the order (S170a). A vendor may also be granted access to the design.

If the design is rejected by the customer (S160b), who comments as to why the design was rejected. The graphic artist will be notified of the rejection. Methods of notification include but are not limited to phone communications or any electronic communications, such as email or text messages (S161). Then, the graphic artist completes a revised design (S162), which the customer again either accepts (S160a) or rejects with comments (S160b).

If the customer accepts the revised design (S160a), depending upon the type of package, either the transaction is complete, i.e. the order is fulfilled (S170a), or the design is routed to a vendor (S170b) or accessed by a vendor, who will create the final package and deliver it to the customer (S171), fulfilling the order (S170a).

If the revised design is again rejected by the customer (S160b), the customer and the graphic artist will communicate to make necessary corrections and adjustments (S161). The graphic artist will be notified of the rejection. Methods of notification include but are not limited to phone communications or any electronic communications, such as email or text messages. (S161). Then, the graphic artist completes a revised design (S162), which the customer again either accepts (S160a) or rejects with comments (S160b). The revision process may continue until the customer accepts the artist's design.

In one embodiment of the invention, the job trafficker is notified along with the graphic artist when a design is rejected.

In one embodiment, the general customer profile information supplied by the customer that appeared in the specification is retained (S180) and reused. When the customer purchases another package, the customer only supplies information relevant to the specific package as the existing customer profile information is integrated into the specifications that are sent to the graphic artist (S190).

In another embodiment of the method, the customer may already possess a graphic design that he or she wishes to have integrated as the art for a package available for selection. In this embodiment, when the customer purchases a package S110, the customer indicates that he or she already possessing art, defining the requirements S120 includes supplying the art as part of the specifications. In one aspect, the customer still creates a retained client profile S180.

As the art is already included in the specifications, the package order is routed to a vendor (S170b), who will create the final package and deliver it to the customer (S180), fulfilling the order (S170a).

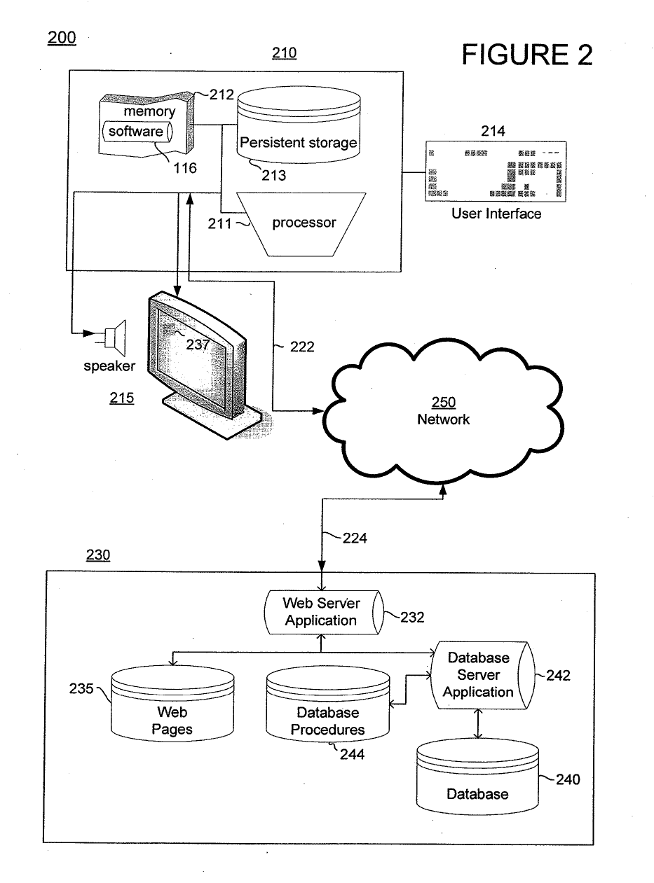

Referring to FIG. 2, the computer architecture 200 of an embodiment of the present invention is shown. In an embodiment, the system and method of the present invention are directed to a computer in communication with a server through the Internet. Referring to FIG. 2, one or more client computers 210 and a server computer 230 are coupled over communication links 222, 224, respectively to network 250. Network 250 may comprise, for example, the Internet, a wide area network (WAN), or a local area network (LAN). Together, software that executes on a client computer 210 and on server computer 230 forms a client/server software system.

Client computer 210 comprises a processor 211, memory 212, user interface 214 and a display 215. Memory 212 may also include persistent storage 213. In an embodiment, software on client computer 210 comprises a Web browser 216, such as Internet Explorer™, Netscape™, Firefox™, Safari™ or other Web browser pre-loaded into memory 212 of client computer 210 or readily-available for download from the Internet into memory 212. Such browsers retrieve Web pages 235 from a Web server 230 in response to inputs on user interface 214. Web pages 235 are loaded into memory 212 and then rendered on display 215. In this embodiment, software on the client computer 210 additionally comprises an email client for sending and receiving email.

User interface 214 comprises controls that are preferably graphically represented buttons 237, with symbols commonly found in many Web pages to permit entry of information or selection of actions. User interface 214 may be a keyboard, mouse or other pointing device, or other information or control input device that affects the operation of client computer 210, as is well known in the art.

Display 215 comprises a CRT (cathode ray tube) or LCD (liquid crystal display), or other visual display device as is commonly known in the art. Display 215 may further comprise speakers that receive digitized audio signals and emit audio output audible to the user.

Software on server computer 230 preferably comprises a Web server application 232. Web server application 232 listens for TCP/IP (transport control protocol/Internet protocol) connections on a well-known port and receives standard HTTP (hyper-text transfer protocol) requests on that port that identifies particular URL (universal resource locator) that indicates Web pages 235 and other information requested, typically by Web browser 216 on client computer 210. Preferably, Web server application 232 comprises Apache and a collection of software modules that generate HTML (hyper-text markup language) Web pages 235. The Web server additionally comprises software capable of sending email, such as the sendmail package. In alternate embodiments, the functions performed by server computer 230 are split among several server computers, for example, having components of Web server application 232 executed on computers different from database server application 242 (described below). Furthermore, these servers may be geographically separated and, for example, coupled through network 250.

In addition, server computer 230 includes a database 240 that includes information related to available packages and graphic artists. A database server application 242 is coupled to database 240 and provides an interface to the information stored in database 240 to other application software modules that execute on server computer 230. In an embodiment, database 240 is a relational database, which includes a number of interrelated tables. Database server application 242 is preferably an SQL (structured query language) server that accepts queries according to an SQL syntax and provides responses to those queries. Database server application 242 can perform stored database procedures 244 comprising complex queries stored in SQL syntax on server computer 230. Such queries may involve multiple fetching processes from more than one table in the tables that comprise database 240. Stored database procedures 244 are stored in a file system on server computer 230.

Although FIG. 2 illustrates only one server computer 230 and one client computer 210 in communication through network 250, it should be understood that different numbers of computers may be utilized. In one example, the claimed method and system may comprise a single, stand-alone computer, in which case the network would comprise the internal data communication bus of such computer. In another example, the network 250 may include a plurality of network computers and tens or hundreds of computers, all of which may be interconnected via the network 250. In an embodiment, a plurality of client computers 210 is able to simultaneously connect to the server 230. The communication links 222, 224 may be provided as a dedicated hardwired link or a wireless link. Although the communication links 222, 224 are shown as a single data link, they may comprise multiple data links.

The networked computers, client computer 210 and server computer 230, may be provided in many different geographic locations including homes and offices, different areas of the same city, or they may be located in different states or even countries. Network 250 may include a plurality of network computers or server computers (not shown), each of which may be operatively interconnected. Where the network 250 comprises the Internet, data communication may take place over communication links via an Internet communication protocol (UDP/IP or TCP/IP). Where the network 250 comprises a wireless network, data communication may take place over communication links via a wireless data protocol such as CDMA2000 or W-CDMA. Similarly, where the network communications comprise data, voice and video, communication may take place via an Internet communication protocol or a wireless protocol.

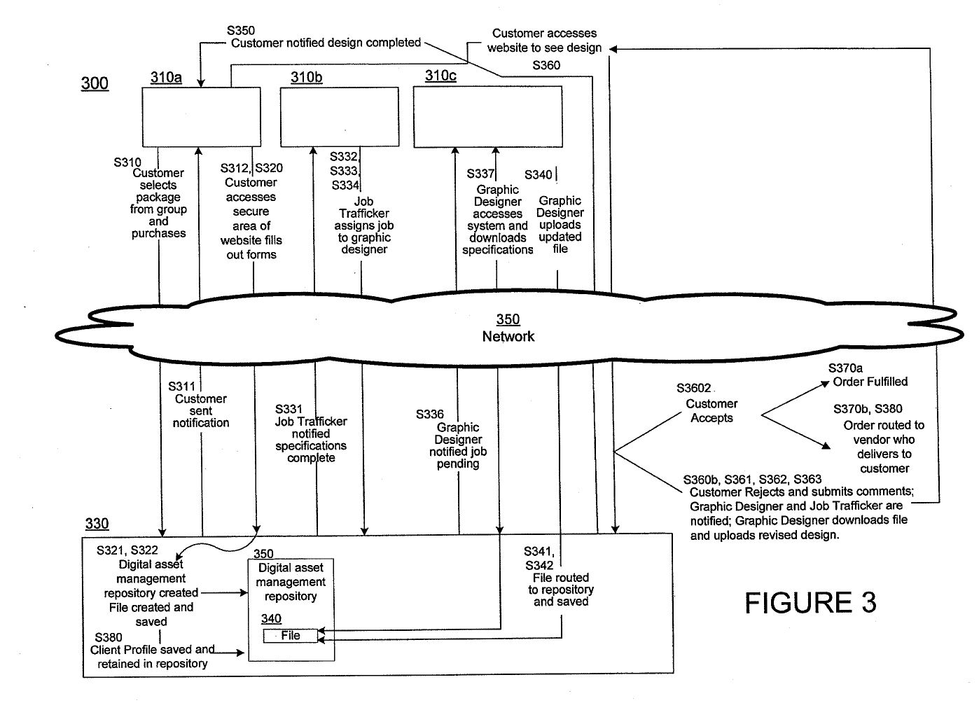

Referring to FIG. 3, an embodiment of the workflow of the system 300 is shown. In this embodiment, a customer utilizes the Web Browser on a client computer 310a to access a Web Site and purchase a package selected from a group of available packages (S310). The data regarding the packages is preferably stored in the database and served to the customer for selected via the database server, which connects to the server 330, which serves the Web site to the client computer over a network, preferably the Internet. The package represents a custom graphic art product, including but not limited a logo, a printed item, a promotional product, a Web site, a display item, an exhibit, an audio service or a video service, and/or a published CD or DVD. At this point, the actual package that embodies the product that will be ultimately delivered to the client has not yet been created. It is created in collaboration with a graphic artist. However, this pre-purchase facilitates the further operation of the system.

Once the package is purchased, the information about the purchase is saved on either the Web server or in the database. The customer is then sent an electronic notification (S311), for example, an email and/or a text message, by the server 330, over the network. This notification includes secure information that the customer will use to access the Web site again. Secure information includes but is not limited to a link embedded in an email or text message and/or a username and password embedded in an email or text message.

The customer utilizes the secure information to access a secure area of the Web site (S312) over the network.

Once the customer has accessed the Web site with this secure information, the customer is served forms, e.g. web forms that the customer fills out and submits to define the customized requirements or specifications for the package (S320). The forms prompt the customer to provide information including but not limited to content and assets for the job, specific data related to the job, called a job ticket, as well as general information about the customer itself, called a client profile, which will assist the assigned graphic artist in fulfilling the job for the customer.

When the specifications are complete, the package order is routed to a qualified graphic artist. In one aspect of the invention, the routing is handled by a job trafficker, an individual preferably with an artistic background, who can use this expertise to select an appropriate artist to create the package, based upon elements including but not limited to the package selected, the specifications submitted by the customer, and the skill sets of the available graphic artist. The job trafficker will then notify the selected graphic artist that he or she had been selected for the package and send the specifications to the selected graphic artist.

In one embodiment, the job trafficker is notified electronically that specifications for a purchased package have been completed by a customer (S331). The job trafficker utilizes a client computer 310b to access the system preferably with secure login credentials (S332). The job trafficker views all pending jobs, the specifications associated with each pending job, and a list of the available graphic artists who can take the jobs (S333). The job trafficker selects an appropriate graphic artist for the pending job, assigning the job to the graphic artist (S334).

In another embodiment of the system, the job of the job trafficker is handled automatically within the system based upon pre-programmed criteria and stored information about the graphic artists. The system electronically evaluates the package and selects an appropriate artist based upon the logic programmed into the system.

Once the specification is complete, the server converts the data supplied by the customer into a specifications file 340 (S321). The system creates a digital asset management repository 350 for the customer and deposits and saves the specification file into this repository (S322). Metadata in the file 340 indicates its ownership by the customer.

Once the graphic artist is selected, the server 330 notifies the graphic artist, e.g. via email or a text message, that he or she has a job pending in the system (S336). This notification includes secure information that the graphic artist will use to access the Web site. Secure information includes but is not limited to a link embedded in an email or text message and/or a username and password embedded in an email or text message.

The graphic artist utilizes the secure information to access a secure area of the Web site via a client computer 310c over the network and downloads the specifications file 340 from the customer's digital asset management repository 350 (S337).

One embodiment of this invention allows the artist, upon securely accessing the system, to view only the package that was just assigned, its assignment triggering the notification. Another embodiment allows the graphic artist to view all packages that are assigned to him or her and pending in the system each time he or she accesses the system.

After downloading the specifications file 340, the selected graphic artist completes the graphic design for the package, saves the design into the file 340, and uploads the file to the server 330 (S340). Depending upon the nature of the package, this graphic design may signify the completed package, i.e., a fulfilled order. For example, if the package purchased is a logo, the graphic artist creates a logo in order to create the package, i.e., fulfill the order. However, if the package is a display item, such as a banner, although the graphic artist creates the design, the physical banner that includes the design may not be produced by the graphic artist, but instead routed to a vendor, such as a copy center, with the facilities and equipment to emboss graphic art onto a banner.

Based on the metadata in the file 340, the system routes the file to the digital asset repository of the customer (S341). The system saves the file into this repository (S342), an action which triggers an electronic notification to the customer (S350) that the design is complete.

The graphic artist may use any method known to one of ordinary skill in the art to upload the file 340 to the server 330, e.g., ftp and sftp. In one embodiment, the graphic designer has an icon on the desktop of his or her client computer 310c that launches a pre-installed and pre-configured ftp program that uploads the file 340 to the server 330. The graphic designer need only click the icon to run the program.

Upon receiving notification that the design is complete, the customer securely accesses the Web site and evaluates the design (S360) to see whether it conforms to his or her needs and expectations. The customer uses the secure access information supplied earlier to access the site and upon accessing the site, can view his or her own digital asset management repository, which include the completed graphic design.

In the repository, the customer accesses the file 340 and is prompted by the system to accept or reject the design. If the customer is satisfied with the design, he or she accepts the design (S360a). If the customer is not satisfied with the design, he or she rejects the design (S360b). The acceptance or rejection of the design via the webpage can be accomplished in any manner known to one of ordinary skill in the art, including checking a web page control such as a checkbox or selecting a radio button.

If the design is accepted by the customer (S360a), depending upon the type of package, either the transaction is complete, i.e. the order is fulfilled (S370a), or the design is routed to a vendor (S370b), who will create the final package and deliver it to the customer (S380), fulfilling the order (S370a). The vendor information is stored in the database and the system assigns a vendor based upon pre-programmed logic which allows it to determine which vendors are appropriate for which packages. In an alternate embodiment, the vendor is granted access to the repository in the same manner as the graphic artist.

If the design is rejected by the customer (S360b), the customer will submit comments explaining the rejection. The graphic designed is then sent an electronic notification (S361), for example, an email and/or a text message, by the server 330, over the network. In one embodiment, the job trafficker is also notified that a job has been rejected. The graphic artist will securely access the system, download the file 340, view the comments accompanying the rejection, and revise the graphic design (S362). Then, the graphic artist saves the revised design to the file 340 and uploads a revised design to the system (S363). The customer again either accepts (S360a) or rejects (S360b) the design.

If the customer accepts the revised design (S360a), depending upon the type of package, either the transaction is complete, i.e. the order is fulfilled (S370a), or the design is routed to a vendor (S370b), who will create the final package and deliver it to the customer (S171), fulfilling the order (S370a).

If the revised design is again rejected by the customer (S360b), the graphic designed is then sent an electronic notification (S361), for example, an email and/or a text message, by the server 330, over the network. In one embodiment, the job trafficker is also notified that a job has been rejected. The graphic artist will securely access the system, download the file 340, view the comments accompanying the rejection, and revise the graphic design (S362). Then, the graphic artist saves the revised design to the file 340 and uploads a revised design to the system (S363). The revision process may continue until the customer accepts the artist's design.

In one embodiment, the general customer profile information supplied by the customer that appeared in the specification is retained in the digital asset management repository (S380) and reused. When the customer purchases another package, the Web site only requests that the customer supply information relevant to the specific package, as the existing customer profile information is integrated into the specifications that are available to the graphic artist (S390).

In another embodiment of the system, the customer may already possess a graphic design that he or she wishes to have integrated as the art for a package available for selection. In this embodiment, when the customer purchases a package S310, the customer indicates while accessing the Web site that he or she already possesses art.

Once the package is purchased, the information about the purchase is saved on either the Web server or in the database. The customer is then sent an electronic notification (S311), for example, an email and/or a text message, by the server 330, over the network. This notification includes secure information that the customer will use to access the Web site again. Secure information includes but is not limited to a link embedded in an email or text message and/or a username and password embedded in an email or text message.

The customer utilizes the secure information to access a secure area of the Web site (S312) over the network.

Once the customer has accessed the Web site with this secure information, the customer is served forms, e.g. web forms that the customer fills out and submits to define the customized requirements or specifications for the package (S320). The forms prompt the customer to provide information including but not limited to content and assets for the job, specific data related to the job, called a job ticket, as well as general information about the customer itself, called a client profile, which will assist the assigned graphic artist in fulfilling the job for the customer. To define the specifications, in addition to filling out the forms, in this embodiment, the customer will upload the pre-existing art that he or she wants to have incorporated into the package.

When the specifications are complete, the package order is routed to a vendor (S370b), who will create the final package and deliver it to the customer (S380), fulfilling the order (S370a). The vendor information is stored in the database and the system assigns a vendor based upon pre-programmed logic which allows it to determine which vendors are appropriate for which packages.

What is claimed is:

1. A computerized system for providing user requested content comprising:
at least one data input/output unit configured to receive first data defining the user requested content and to receive second data from a second entity;
an analysis unit configured to allow analysis of the first data;
at least one routing unit configured to route the first data to the second entity based on the results of the analysis and to route the second data to the first entity; and
a storage unit configured to store the first data and the second data in a manner wherein the first data and the second data are accessible by at least the first entity and the second entity.

2. The system of claim 1 wherein the first data comprises an order for graphic art or products incorporating graphic art.

3. The system of claim 2 wherein the first data further comprises a client profile.

4. The system of claim 3 wherein the second data comprises graphic art or products incorporating graphic art.

5. The system of claim 4 wherein the second entity is a graphic artist.

6. The system of claim 4 wherein the analysis is performed by a job trafficker.

7. The system of claim 4 wherein the storage unit is a digital asset management repository.

8. The system of claim 1 wherein the routing unit is further configured to route the first data and the second data to a third entity.

9. The system of claim 8 wherein the storage unit is accessible by the third entity.

10. A method for providing user requested content via a computer, the computer including one or more processors configured to:
receive first data defining the user requested content;
present first data for analysis;
route the first data to a second entity based on the results of the analysis;
receive second data from the second entity, the second data containing a response to the first data;
route the second data to the first entity; and
store the first data and the second data in a manner wherein the first data and the second data are accessible by at least the first entity and the second entity.

11. The method of claim 10 wherein the first data comprises an order for graphic art or products incorporating graphic art.

12. The method of claim of claim 11 wherein the first data further comprises a client profile.

13. The method of claim 12 wherein the second data comprises graphic art or products incorporating graphic art.

14. The method of claim 13 wherein the second entity is a graphic artist.

15. The method of claim 13 wherein the analysis is performed by a job trafficker.

16. The method of claim 13 wherein the storage unit is a digital asset management repository.

17. The method of claim 10 wherein the computer is further configured to route the first data and the second data to a third entity.

18. The method of claim 17 wherein the first data and the second data are accessible by the third entity.
